(19) United States
(12) Patent Application Publication
(10) Pub. No.: US 2025/0062852 A1
(43) Pub. Date: Feb. 20, 2025

(54) Transfer of Signaling Context Associated With a Wireless Device

(71) Applicant: Telefonaktiebolaget LM Ericsson (PUBL), Stockholm (SE)

(72) Inventors: Nizar Kheir, Gif sur Yvette (FR); Loay Abdelrazek, Solna (SE)

(21) Appl. No.: 18/722,743

(22) PCT Filed: Dec. 24, 2021
(86) PCT No.: PCT/IB2021/000960

§ 371 Date: Jun. 21, 2024

(51) Int. Cl. H04K 3/00; H04W 12/122

(52) U.S. Cl. CPC H04K 3/22; H04W 12/122; H04K 2203/16

(57) ABSTRACT

Methods, access network devices and computer programs in a radio access network (100) comprising a first network function, NF1, (140) and a second network function, NF2 (150). The access network device is configured to obtain, in the NF1 (140), information indicating an anomalous behavior of a wireless device (125), WD. The access network device is configured to initiate copying or transfer of a signaling context (260) associated with the WD (125) and existing in the NF1, from the NF1 to the NF2 (150). A computer program product is also disclosed. An access network device is configured to receive signaling from a wireless device, WD, (125), whereby a transfer of the signaling context associated with the WD between an NF1, and an NF2 is internal to the radio access network.

### TECHNICAL FIELD

The invention relates to methods performed by an access network device, access network devices, corresponding computer programs and a corresponding computer program product.

### BACKGROUND

Modern Radio Access Networks are designed to implement a set of standardized regulatory and best practice security procedures during their design and operation, in compliance with applicable security regulations. However, some networks often contain security flaws and vulnerabilities that are unknown and often times unique to every network even despite standardized protocols and procedures for network operation in the case of radio access networks. This is often due to potential flaws in the implementation or potential weaknesses in the protocols and procedures as standardized. Presently, network designers and operators are provided with the ability to improve and harden the security of the radio access network during the design phase and to monitor behavior during network operation to detect anomalous user behavior. Once detected, the network operator has the ability to expel the potential attacker from the network in order to protect the radio access network resources from becoming compromised. This approach however has several drawbacks.

Firstly, given that the attacker is expelled from the network, the attacker may learn dangerous information about how the network may react to actions taken by the attacker and thereby determine further weaknesses and vulnerabilities in the network. Secondly, given that the attacker is expelled from the network, the network operator is unable to gather valuable intelligence from the attacker to further improve the networks operational security. These two drawbacks are of crucial importance to network designers and operators which if they were to be improved upon would allow for more secure and proactive measures to be taken to secure the radio access networks in the present and into the future.

A web-based network may improve on this problem by exposing a new, isolated attack surface that acts as a sandbox for which the attacker may interact with, which is isolated from the rest of the network. This allows for protection of the network whilst gathering important intelligence about the attacker's actions thereby improving on these two drawbacks.

U.S. Pat. No. 10,887,346 B2 discloses a rapid deployment of application-level deceptions which implant cyber deceptions into running legacy applications both on production and decoy systems. Once a deception is tripped, the affected code is moved into a decoy sandbox for further monitoring and forensics. The disclosure provides for unprivileged, lightweight application sandboxing to facilitate monitoring and analysis of attacks as they occur. Preferably, the approach transparently moves the suspicious process to an embedded decoy sandbox, with no disruption of the application workflow.

Currently no such improvements exist however at the radio access network level.

### SUMMARY

An object of the invention is to enable an isolated attack surface that may act as a sandbox with which a wireless device may interact.

According to a first aspect of the invention, there is provided a method performed in a radio access network by an access network device, which comprises a first network function, NF1, and a second network function, NF2. The method comprises obtaining, in the NF1, information indicating an anomalous behavior of a wireless device, WD. The method comprises initiating copying or transfer of a signaling context associated with the WD and existing in the NF1, from the NF1 to the NF2. Hereby is achieved a solution for enabling an isolated attack surface for a network where both the network and devices interacting with the network are directly identifiable, authenticated and directly reachable to each other. This isolated attack surface would make deception possible to implement. This allows for the protection of real assets such as NF1 in the radio access network while also convincing the WD to waste computational resources in interacting with the NF2.

In an embodiment of the first aspect the signaling context comprises a shared secret or an identifier of the shared secret. In an embodiment of the first aspect the signaling context comprises a carrier frequency. In an embodiment of the first aspect the signaling context comprises a transmission reception window comprising a time and a bandwidth. Hereby is achieved the possibility for a network function to deceive the WD when connecting via a radio access network.

In an embodiment of the first aspect, the signaling context comprises information indicative of WD capability. In an embodiment of the first aspect, the signaling context comprises information indicative of measurements taken by the WD. In an embodiment of the first aspect, the signaling context comprises information indicative of security related to the WD. In an embodiment of the first aspect, the signaling context comprises information indicative of information required to maintain radio access network services; In an embodiment of the first aspect, the signaling context comprises Information indicative of WD state information; or

In an embodiment of the first aspect, the signaling context comprises information indicative of a WD associated logical connection with a network function, the network function located in the access network device. In an embodiment of the first aspect, the signaling context comprises information indicative of a WD associated logical connection with a network function, the network function located in the access network device. In an embodiment of the first aspect, the signaling context comprises information indicative of a WD associated logical connection with a network function, the network function located in the radio access network. In an embodiment of the first aspect, the signaling context comprises information indicative of a WD associated logical connection with a network function, the network function located in a different network. Advantageously, a network function is able to provide more RAN functionality to the WD while further deceiving the WD. This results in longer isolation of the WD from other, more vulnerable parts of the network before the WD requests a service that the access network device does not have the capability to replicate.

In an embodiment of the first aspect, the method comprising stopping transmission to the WD from NF1 currently providing radio access. In an embodiment of the first aspect, the method comprising beginning transmission to the WD, wherein the transmission originates from NF2 using the signaling context from NF1. Hereby is achieved a deception of the WD when it is actively signaling with the network.

In an embodiment of the first aspect, the method comprising initiating transfer of a signaling associated with the WD, from the NF1 to the NF2 wherein, during the transfer and thereafter the NF2 uses information indicative of an identity associated with NF1. Hereby is achieved a deception of the WD when it is actively signaling with the network.

In an embodiment of the first aspect, the method comprising deriving information indicative of an anomalous behavior of the WD by receiving a signaling from the WD. This is advantageous as it limits of the use of computational resources of the access network device by waiting with a deception until the WD is signaling to the network.

In an embodiment of the first aspect, the method comprising obtaining the information indicating the anomalous behavior of the WD from a database. In an embodiment of the first aspect, the method comprising obtaining the information indicating the anomalous behavior of the WD from the access network device. In an embodiment of the first aspect, the method comprising obtaining the information indicating the anomalous behavior of the WD from a detection function. Advantageously, this results in a faster implementation of deception given that the access network device is now capable of preparing a deception before the device is even connected. Additionally, there is an improvement in the quality of information indicating the anomalous behavior given that the information may be obtained from multiple sources.

In an embodiment of the first aspect, the anomalous behavior comprises repeated signaling associated with the WD. In an embodiment of the first aspect, the anomalous behavior comprises unexpected signaling associated with the WD. In an embodiment of the first aspect, the anomalous behavior comprises non 3GPP compliant signaling associated with the WD. In an embodiment of the first aspect, the anomalous behavior comprises previously identified anomalous identifier associated with the WD. In an embodiment of the first aspect, the anomalous behavior comprises anomalous location of the WD. In an embodiment of the first aspect, the anomalous behavior comprises anomalous measurement reporting by the WD. Advantageously, this allows for the detection of anomalous behavior by, for example, the access network device.

In an embodiment of the first aspect, the method comprising initiating the creation of NF2. This is advantageous as the access network device may then reduce the use of computational resources given that the NF2 may be created when needed and does not have to always be running.

In an embodiment of the first aspect, the method comprises receiving from a network orchestrator, a request for initiation of the creation of the NF2.

In an embodiment of the first aspect, the method comprises receiving from the network orchestrator, a message comprises a confirmation of creation of the NF2.

In an embodiment of the first aspect, the method comprises terminating the NF2. This is advantageous as the access network device may reduce the use of computational resources given that the NF2 may be terminated when not needed and does not have to always be running.

In an embodiment of the first aspect, the NF2 is terminated after a set amount of time. In an embodiment of the first aspect, the NF2 is terminated after an amount of time where no interactions with the WD occur. In an embodiment of the first aspect, the NF2 is terminated after a number of interactions with the WD. In an embodiment of the first aspect, the NF2 is terminated after an amount of access network device resources used. In an embodiment of the first aspect, the NF2 is terminated after a specific interaction between the NF2 and the WD. In an embodiment of the first aspect, the NF2 is terminated after a certain set of interactions between the NF2 and the WD. This is advantageous as the access network device may reduce the computational resources given that the NF2 may be terminated when defined conditions are met and does not have to always be running. Additionally, the WD is also connected until such a time that a specific condition is met, preventing the WD from interacting with network in different possibly more dangerous ways.

In an embodiment of the first aspect, the method comprises sending a message to a network orchestrator requesting the termination of the NF2.

In an embodiment of the first aspect, the method comprises receiving from a network orchestrator, a message comprises a confirmation of the termination of the NF2.

In an embodiment of the first aspect, the access network device comprises a third network function, NF3. Hereby is achieved the enablement of deception in radio access networks with distributed functions

In an embodiment of the first aspect, the access network device comprises the NF3 and a fourth network function, NF4. Advantageously, this enables the protection of distributed functions NF3, from WDs exhibiting anomalous behavior, in radio access networks.

In an embodiment of the first aspect, the method comprises creating the NF4. Advantageously, this reduces computational resources since the NF4 may be created when needed and does not have to always be running.

In an embodiment of the first aspect, the method comprises sending a message to a network orchestrator requesting the creation of the NF4.

In an embodiment of the first aspect, the method comprises receiving from a network orchestrator a message comprises a confirmation of creation of the NF4.

In an embodiment of the first aspect, the method comprises initiating transfer of a signaling context associated with the WD, from the NF3 to the NF2. Hereby is achieved is enabling deception in the radio access network when an NF3 exists and has interactions with the WD.

In an embodiment of the first aspect, the method comprises initiating transfer of a signaling context associated with the WD, from the NF3 to the NF2 and/or the NF4. Hereby is achieved is enabling deception in the access network device containing an NF3

In an embodiment of the first aspect, the method comprises initiating transfer of a signaling associated with the WD, from the NF3 to the NF2. Advantageously, a deception of the WD when it is actively signaling with the network, and more specifically, with the NF3 is then possible

In an embodiment of the first aspect, the access network device comprises the NF4 with at least some capabilities of a NF3 and NF4 uses information indicative of an identity associated with as the NF3 to the WD. This is advantageous as it allows for the access network device to run a more elaborate and robust deception towards the WD as a network function beyond NF1 may be also be replicated.

In an embodiment of the first aspect, the method comprises initiating redirection of signaling associated with the WD, from the, NF3, to NF4, and maintaining the redirection internally to the access network device. This is advantageous as the NF3 is isolated and protected from WDs exhibiting anomalous behavior in addition to the enablement of deception of the WD.

In an embodiment of the first aspect, the access network device comprises is a 3GPP 5G access network device. Advantageously, this allows for deception in 3GPP 5G radio access networks.

In an embodiment of the first aspect, the access network device comprises a gNodeB Central Unit as the NF1. Advantageously, this allows for deception in 3GPP 5G radio access networks.

In an embodiment of the first aspect, the access network device comprises a gNodeB Distributed Unit, as the NF3. Advantageously, this allows for deception in 3GPP 5G radio access networks.

In an embodiment of the first aspect, the method comprises initiating a transfer of a signaling context associated with the WD, through the F1 interface. Hereby is achieved Advantageously, the complexity of the radio access network is limited through the reuse of a preexisting interface.

In an embodiment of the first aspect, the method comprises initiating a transfer of a signaling associated with the WD, through the F1 interface. Advantageously, the complexity of the radio access network is limited through the reuse of a preexisting interface.

In an embodiment of the first aspect, the method comprises initiating a transfer of a signaling associated with the WD, from the NF1 to the NF2, the initiating comprises the transmission of a message over the F1 interface containing an informational element value indicating a wireless device exhibiting anomalous behavior and wherein the informational element value indicates to the access network device to send only signaling to the WD indicative of either NF1, NF3 or both. Advantageously, the complexity of the radio access network is limited through the reuse of a preexisting interface.

In an embodiment of the first aspect, the method comprises initiating a transfer of a signaling associated with the WD, from the NF3 to the NF4, the initiating comprises a transmission of a message over the F1 interface containing an informational element value indicating a wireless device exhibiting anomalous behavior and indicating to the access network device to send only signaling to the WD indicative of either NF1, NF3 or both. Advantageously, the complexity of the radio access network is limited through the reuse of a preexisting interface.

In an embodiment of the first aspect, the informational element causing the NF2 to send a message indicating a status of the transfer of signaling associated with the WD and the NF1 to cease signaling with the WD. Advantageously, the complexity of the radio access network is limited through the reuse of a preexisting interface to successfully initiate a deception.

In an embodiment of the first aspect, the informational element value initiates the NF1 to omit a transmission action indicator in a UE context modification message to NF3. In an embodiment of the first aspect, the informational element value initiates the NF1 to an RRC connection reconfiguration message in a UE context modification message to NF3. In an embodiment of the first aspect, the informational element value initiates the NF1 to omit the transmission action indicator and the RRC connection reconfiguration message. Advantageously, the complexity of the radio access network is limited through the reuse of a preexisting interface whilst preventing the WD from learning of a modification.

According to a second aspect of the invention, there is provided a method performed in a radio access network by an access network device comprises an NF2. The method comprises receiving signaling from a WD, whereby a transfer of the signaling context associated with the WD between a NF1, and the NF2 is internal to the radio access network. Hereby is achieved a solution for operating an isolated attack surface for a network where both the network and devices interacting with the network are directly identifiable, authenticated and directly reachable to each other. This isolated attack surface enables an ongoing deception. This increases the protection of more vulnerable assets such as NF1 in the radio access network, given that the assets are not interacting directly with the WD while also convincing the WD to continue to waste computational resources in interacting with the NF2.

In an embodiment of the second aspect, where the transfer of the signaling context associated with the WD between NF1 and NF2 was internal to both the radio access network and a different network. Advantageously, this allows for the signaling context to be transferred over other intermediary networks allowing for easier, faster, or more secure transfer.

In an embodiment of the second aspect, the method comprises interacting with the WD through further signaling, only after successful transfer to NF2, of a signaling context associated with NF1. Advantageously, this prevents deception ruining signaling from taking place before the necessary signaling context is successfully copied or transferred thereby improving the likelihood of successful deception.

In an embodiment of the second aspect, the method comprises monitoring the received signaling from the WD. Advantageously, this allows for the access network device to detect potentially harmful interactions on the part of the WD.

In an embodiment of the second aspect, the method comprises recording the received signaling from the WD. Advantageously, this allows for future interactions to be compared against the recorded interactions thereby allowing for dangerous behavior to be detected earlier and leading to an increased protection of the access network device.

In an embodiment of the second aspect, the method comprises storing records of the received signaling from the WD. Advantageously, this allows for offloading of the resources of the access network devices as these records can be stored in other, less resource intensive, storage mediums

In an embodiment of the second aspect, the method comprises transmitting the records of the received signaling from the WD. Advantageously, this allows for the analysis of the received signaling from the WD by an expert or computer program outside of the access network device. This would allow for the improvement of threat intelligence in relation to WDs and radio access networks.

In an embodiment of the second aspect, the method comprises terminating the NF2. Advantageously, this leads to a reduction of computational resources given that the NF2 may be terminated when not needed and does not have to always be running.

In an embodiment of the second aspect, the method comprises terminating the NF2 after a set amount of time. In an embodiment of the second aspect, the method comprises terminating the NF2 after an amount of time where no interactions with the WD occur. In an embodiment of the second aspect, the method comprises terminating the NF2 after a number of interactions with the WD. In an embodiment of the second aspect, the method comprises terminating the NF2 after an amount of access network device resources used. Advantageously, this leads to a reduction of computational resources given that the NF2 may be terminated when specific criteria are met and does not have to always be running.

In an embodiment of the second aspect, the access network device comprises an NF3. Advantageously, this allows for deception in networks with distributed radio access network functionality.

In an embodiment of the second aspect, the access network device comprises a gNodeB Distributed Unit as the NF3. Advantageously, this allows for deception in 3GPP 5G radio access networks.

In an embodiment of the second aspect, the access network device comprises an NF3 and an NF4. In an embodiment of the second aspect, the access network device comprises a fourth network function, NF4, with at least some capabilities of a NF3 and appearing the same as the NF3 to the WD. Advantageously, this allows for deception in 3GPP 5G radio access networks.

In an embodiment of the second aspect, the access network device is a 3GPP 5G access network device. Advantageously, this allows for deception in 3GPP 5G radio access networks.

In an embodiment of the second aspect, the access network device comprises a second network function NF2, where NF2 has at least some of the capabilities of a gNB-CU and appears the same as a gNB-CU to the WD. Advantageously, this allows for deception in 3GPP 5G radio access networks.

In an embodiment of the second aspect, the method comprises NF2 interacting with the NF3, the interaction being based on interactions with the WD. Hereby is achieved [tech].

In an embodiment of the second aspect, the method comprises interacting at NF2 with an NF4, the interactions being based on interactions with the WD.

In an embodiment of the second aspect, the method comprises interacting at NF2 with a fifth network function, NF5, the interactions being based on interactions with the WD. Advantageously, this allows for more functionality in the NF2 for running the deception towards the WD.

In an embodiment of the second aspect, the method comprises interacting at NF2 with the NF5, NF5 having at least some of the capabilities of a core network connected the access network device and appearing the same as a core network to the WD. Advantageously, this the deception towards the WD to be expanded to core network functionalities allowing for a more elaborate deception, more records to be gathered of WD received signaling and for the WD to stay connected to the network for longer.

In an embodiment of the second aspect, the method comprises interacting at NF2 with the NF5, NF5having at least some of the capabilities of an Access and Mobility Management Function connected to the access network device and appearing the same as an AMF to the WD. Advantageously, this the deception towards the WD to be expanded to AMF functionalities allowing for a more elaborate deception, more records to be gathered of WD received signaling and for the WD to stay connected to the network for longer.

According to a third aspect of the invention, there is an access network device in a radio access network that comprises an NF1. The access network device comprises processing circuitry and storage medium, the storage medium containing instructions executable by the processing circuitry. The processing circuitry is operative to obtain in the NF1, information indicative of anomalous behavior of a wireless device, WD. The processing circuitry is operative to initiate copying or transfer of a signaling context associated with the WD and existing in the NF1, from the NF1 to the NF2.

In an embodiment of the third aspect, there is an access network device that comprises an NF1, in a radio access network. The access network device comprises processing circuitry and storage medium, the storage medium containing instructions executable by the processing circuitry. The processing circuitry is operative to perform the method according to any one of the embodiments of the first aspect of the invention.

According to a fourth aspect of the invention, there is an access network device in a radio access network that comprises NF2 which has been created by a network orchestrator upon receiving of a request from NF1. The access network device comprises processing circuitry and storage medium, the storage medium containing instructions executable by the processing circuitry. The processing circuitry is operative to receive a signaling context associated with the wireless device, WD from the NF1. The processing circuitry is operative to receive signaling from the WD.

According to a fifth aspect of the invention, there is an access network device in a radio access network that comprises an NF2, has been created by a network orchestrator upon receiving of a request from an NF1. The access network device comprises processing circuitry and storage medium, the storage medium containing instructions executable by the processing circuitry. The processing circuitry is operative to receive signaling from the WD at the NF2 using the signaling context of NF1.

In an embodiment of the fourth and fifth aspect, there is an access network device that comprises an NF1 in a radio access network. The access network device comprises processing circuitry and storage medium, the storage medium containing instructions executable by the processing circuitry. The processing circuitry is operative to perform the method according to any one of the embodiments of the second aspect of the invention.

According to a sixth aspect of the invention, a computer program is provided. The computer program comprises computer readable instructions which is run on processing circuitry of an access network device wherein an NF2 has been created by a network orchestrator upon receiving of a request from an NF1. The computer readable instructions cause the radio access device to receive a signaling context associated with the WD from the NF1. The computer readable instructions cause the radio access device to receive signaling from the WD.

According to a seventh aspect of the invention, a computer program is provided. The computer program comprises computer readable instructions which is run on processing circuitry of an access network device wherein an NF2 has been created by a network orchestrator upon receiving of a request from an NF1. The computer readable instructions cause the radio access device to receive signaling from the WD at the NF2 using the signaling context of NF1.

According to an eighth aspect of the invention, a computer program is provided. The computer program comprises computer readable instructions which is run on processing circuitry of an access network device wherein an NF2 has been created by a network orchestrator upon receiving of a request from an NF1. The computer readable instructions cause the radio access device to perform the method according to any of the embodiments of the first aspect. The computer readable instructions cause the radio access device to perform the method according to any of the embodiments of the second aspect.

According to a ninth aspect of the invention a computer program product is provided. The computer program product comprises a computer program according to one or more of the sixth to eighth aspects of the invention. The computer program product comprises a computer readable storage medium on which the computer program is stored.

### BRIEF DESCRIPTION OF DRAWING

The accompanying drawings, which are incorporated herein and form part of the specification, illustrate various embodiments.

FIG. 1 is a diagram showing functional units of a network according to an embodiment.

FIG. 2 is a signaling diagram showing a process according to an embodiment.

FIG. 3 is an example of a signaling context according to an embodiment.

FIG. 4 is a diagram showing an example of functional units of a 3^{rd} Generation Partnership Project (GPP) 5^{th} generation network according to an embodiment.

FIG. 5 is a diagram showing functional units of a network according to an embodiment.

FIG. 6 is a flow chart illustrating a process according to an embodiment.

FIG. 7 is a schematic diagram showing features according to an embodiment.

FIG. 8 is a flow chart illustrating a process according to an embodiment.

FIG. 9 is a diagram showing network functions of an access network device according to an embodiment.

FIG. 10 is a diagram showing network functions of an access network device according to an embodiment.

FIG. 11 is a diagram showing network functions of an access network device according to an embodiment.

FIG. 12 is a diagram showing functional modules of an access network device according to an embodiment.

FIG. 13 is a diagram showing functional modules of an access network device according to an embodiment.

FIG. 14 is a diagram showing functional modules of an access network device according to an embodiment.

FIG. 15 is a diagram showing functional units of an access network device according to an embodiment.

FIG. 16 shows one example of a computer program product comprising computer readable means according to an embodiment.

### DETAILED DESCRIPTION

The invention will now be described more fully herein with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art. This is especially so in regard to embodiments as related to 5^{th} generation 3GPP radio access networks. The invention should not be misconstrued as being only applicable to a specific generation of 3GPP radio access network or even a 3GPP standardized radio network at all, but rather is purely an example of an implementation of an embodiment of the invention as it relates to such radio access networks.

An access network device is an electronic device that, when activated, communicatively interconnects other electronic devices on the network (e.g., other network devices, end-user devices, etc.). The access network device may be a “multiple service network device” that provides support for multiple networking functions (e.g., Medium Access Control, Radio Link Control, Radio Resource Management, Packet Data Convergence, L2-synchonization, etc.) and/or provides support for multiple application services (e.g., data, localization, voice, and video). The network functions may be virtualized within the network device and perform their functions for one or a combination of the examples presented above, such as a gNodeB (gNB) or an evolved NodeB (eNB) in a 5^{th} Generation (5G) and 4^{th} Generation (4G) base station respectively. They may also perform some or all of the functions of a logical node such as that of a centralized unit or a distributed unit in a gNB. Network functions may exist in several access network devices and network functions belonging to a stack or grouped for a specific purpose may also operate in separate access network devices.

Cloud computing provides on-demand access to a shared pool of hardware resources such as computing resources, storage resources, and networking resources. Cloud computing allows for the request for additional hardware resources when they are needed and to release hardware resources when they are not needed. These hardware resources may be used to virtualize the network functions described above allowing the network functions to be created and run using additional hardware resources shared with other network functions as a part of the access network device. Multiple network functions may run as separate containerized software on the same hardware or may be grouped in a single software instance but operating on physically separate hardware. Cloud computing resources may be managed by a device that they are located in or a network orchestrator that may reside in the device or outside in a separate device.

A wireless device, WD, is simply a device comprising processing circuitry, an attached storage medium, and a communications interface capable of communications through signaling over a wireless medium. A WD may be a 3GPP compatible user equipment. A WD may be a consumer device (such as a mobile phone, modem, vessel, vehicle, wearable electronic device, or drone) or a machine-type communications (MTC) device (such as a sensor, biosensor, or an Internet of Things device, etc.). A WD may also comprise wires for communications or power delivery.

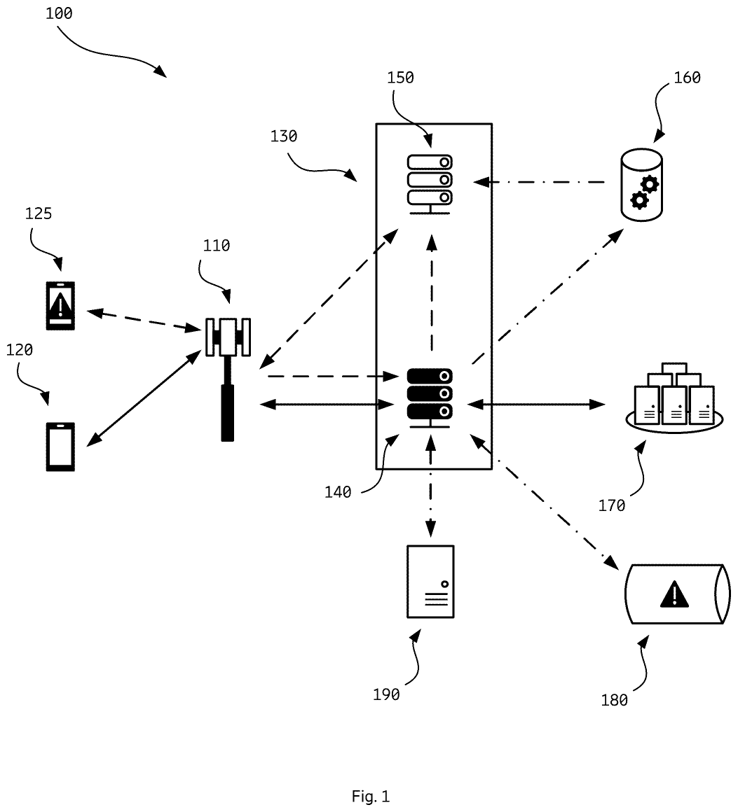

FIG. 1 schematically illustrates an embodiment of the current disclosure where a radio access network 100 is shown. The radio access network is connected to wireless devices where a WD 120 operates normally and a different WD 125 exhibits anomalous behavior from the perspective of, e.g. a 3GPP standard, the WD 125 itself, a device controlled by a network operator, or any other device interacting with the WD 125 or the radio access network 100. The radio access network comprises a base station which in the present embodiment contains a radio antenna 110 connected to an access network device 130 which then connects to a different network 170, for example a core network of a wireless network which comprises the radio access network 100. The access network device initially comprises a network function 140, NF1. The access network device may contain a network orchestrator 160, a database 180, and a detection function 190. The network function is capable of preforming network functionality comprising predetermined actions for interacting with WDs 120 and 125 to facilitate communication between the WDs and the radio access network. The database contains information indicative of WDs and in some embodiments, information indicative of anomalous behavior of WDs. In the present embodiment, the network orchestrator starts, stops, and manages network functions both inside and outside of the access network device. The detection function may detect anomalous behavior associated with a WD. The network orchestrator, database, and detection function may also exist outside the access network device such as in FIG. 1. The access network device may also contain a second network function 150, NF2, which, to the WD, will appear the same as the first network function but may have greater, fewer, or different capabilities. An alternative embodiment of the access network device may also only contain NF2 or NF1 individually in which case the NF2 and NF1 are hosted by two different access network devices which may communicate with each other across devices over a shared protocol or through another network function. This second network function in the present embodiment, may act as a sandbox for radio access network interactions related to and with the WD 125. The term sandbox is used to describe the ability to prevent the WD from interacting with other network functions besides those between the NF2 and the WD which are required for passing signaling. The NF2 acting as the sandbox may be allowed to interact with the WD, which will be described more in detail in examples presented below. Although not presented in FIG. 1, the access network device may contain more network functions that either perform normal radio access network functionality or act as a sandbox for other network functionality. An embodiment of these further network functions is presented in FIGS. 6 through 8. Solid lines with arrows indicate the path of signaling from the normal non-anomalous WD 120 through the radio access network. The dashed lines with arrows indicate the path of signaling from the anomalous WD 125. The dashed and dotted lines with arrows indicate the path of any signaling from the access network device to other network functions or devices in the radio access network, the signaling resulting from the existence and signaling of the anomalous WD.

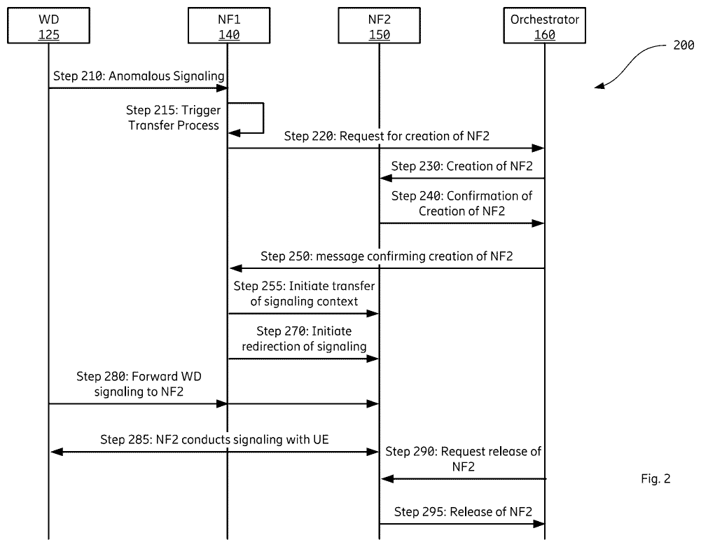

FIG. 2 illustrates a signaling diagram of an embodiment of a method 200. In a first step 210, the WD 125 sends anomalous signaling to the NF1. The NF1 detects this anomalous signaling as anomalous and triggers the UE transfer process in a second step 215.

In the present embodiment, the NF1 obtains information indicative of an anomalous behavior of a WD. This may be done by deriving from received signaling, information indicating an anomalous behavior of the WD. The deriving may result from the signaling itself being anomalous. Anomalous in this context could also, but does not necessarily, mean or imply abnormal, suspicious, or malicious. Anomalous could be exchanged for any of the pervious adjectives provided that the signaling, nature, or behavior matched those adjectives. Anomalous signaling may include signaling, which is repeated signaling, non-standards compliant signaling, and anomalous measurement reporting by the WD. In other embodiments, NF1 already is aware that the WD 125 exhibits anomalous behavior. In other embodiments, the access network device is aware that the WD 125 exhibits anomalous behavior. The information indicating an anomalous behavior of the WD may be obtained from a database 180. This database may contain anomalous WD identifiers such as Subscription Permanent Identifier (SUPI) values, International Mobile Subscriber Identity (IMSI), International Mobile Equipment Identity (IMEI) values, or Integrated Circuit Card Identifier (ICCID) values. The information indicating an anomalous behavior of the WD may be obtained from the detection function 190. The detection function may gather the information from anomalous signaling. The detection function may work in a rule-based format where signaling matches a predetermined rule and thereby is determined to be anomalous. In some embodiments, NF1 or the detection function determines the nature of WD 125 as exhibiting an anomalous behavior aside from any signaling. This indication may also be gathered from the anomalous WD's broadcast location or direction. This indication may also be gathered from any other similar indications of anomalous behavior on the part of the WD known in the art. In embodiments where the NF1 is already aware of the anomalous nature of the WD, the signaling is simply a notification to the NF1 that the anomalous WD is attempting to connect to the radio access network 100. The information indicating an anomalous behavior of the WD may be obtained from both the detection function 190 and the database 180.

Behavior may be considered anomalous, when the behavior of the WD deviates in some way from what is standard, normal, or expected during either the operation of the radio access network, or the communication between the radio access network and the WD. Examples of behavior that are considered as anomalous may be but are not necessarily limited to, repeated signaling associated with the WD, non-3GPP standards compliant signaling associated with the WD, unexpected signaling associated with the WD, the WD being associated with a previously identified anomalous identifier associated with the WD, a specific location of the WD or repeated, non-standard, or unexpected measurement reporting by the WD. This behavior may be considered abnormal when it deviates outside of what is typical or normal operation of a WD 120, for example, behavior set forward by a previously agreed upon standards or other set of actions. This behavior may rise to the level of suspicious when it could be reasonably considered by the skilled person to constitute a potential threat to either the WD 125, the radio access network, or other apparatuses associated with either of the two. This behavior may further rise to the level of malicious, if the behavior is causing or will cause damage to either the WD 125, the radio access network, or other apparatuses associated with either of the two.

Below, several examples of such anomalous behavior are described in the context of 3^{rd}, 4^{th}, and 5^{th} generation 3GPP radio access network. It should be clear to the skilled person how the details of such behavior presented in the 3GPP 3^{rd}, 4^{th}, and 5^{th} generation radio access network examples may be changed to better suit not only other 3^{rd}, 4^{th}, and 5^{th} generation radio access networks but also future radio access networks such as a 6^{th} generation radio access network. These examples of behavior may even be extended to other non 3GPP networks whereby the network is a radio access network using the required signaling context as described in FIG. 2 and the invention as claimed.

A first example of such anomalous behavior is a Radio Resource Control (RRC) Signaling storm. An RRC connection establishment is used by a WD and the radio access network to make the transition from RRC Idle mode to RRC Connected mode. In the example, a WD must make the transition to RRC Connected mode before transferring any application data or completing any other signaling procedures. The normal and standardized procedure of RRC connection establishment is that the WD 120 sends a MSG1 (RACH) to a radio access network. The radio access network then responds with a MSG2 (Random Access Response-RAR) providing the WD 120 with the required resource for RRC connection establishment and scheduling the WD 120 to continue with RRC connection establishment. The WD 120 then sends MSG3 (RRC connection request) to the radio access network and the radio access network receives MSG3. The radio access network then sends MSG4 (RRC connection setup) to the WD 120 and the WD 120 receives MSG4. Finally, the WD 120 acknowledges the MSG4 by sending back the final message of the RRC connection establishment by sending MSG5 (RRC Connection setup complete). Once the radio access network receives MSG5, the WD 120 is then registered to the network and authenticated. A data bearer is then allocated to the WD and the WD will be able, afterwards, to initiate communication with the radio access network. The example of the anomalous behavior, RRC signaling storm, would be for the one or a plurality of WDs 125 exhibits anomalous behavior whereby the WD or WDs repeatedly send MSG3 (RRC connection Request) to the radio access network after receiving MSG2 from the radio access network. The one or plurality of WDs 125 would not respond to a MSG4 from the radio access network with a MSG5 but instead just keep sending MSG3. This behavior may result in upwards of 100s of MSG3 being sent and thereby occupying the resources, such as radio frequency, transmission time or computational resources, of the radio access network. This may even result in the exhaustion of such resources leading to the radio access network not being able to complete RRC connection establishment with other WDs 120. In an example of malicious behavior, this may be done to deny access to the radio access network for other WDs 120, which may be exhibiting completely normal behavior.

An example of how this behavior may be identified as anomalous by a radio access network is to monitor the sequence of the WDs during the RRC setup procedure. If a certain device is not responding to the MSG4 (RRC Connection Setup) sent by the radio access network with the expected MSG5 (RRC Connection Setup Complete) for more than a configurable consecutive time, for example 10 messages, and instead resending MSG3 (RRC Connection Request) again, this can be identified as anomalous behavior. An additional extension of how such behavior may be identified as anomalous is by comparing information identifying the wireless device as potentially characterized by anomalous behavior with information indicative of an identity of the wireless device stored in the database. If a connection is determined to exist, the configurable consecutive messages or time for expecting a MSG5 may be adjust down to 3 messages. If the wireless device then exceeds 3 messages, it's behavior may be identified as anomalous. In this way information indicative of anomalous behavior may be obtained from multiple sources which together indicate anomalous behavior.

A second example of anomalous behavior is the WD 125 providing a fake establishment cause. An RRC connection request has two main informational elements, WD identity and establishment cause. The establishment cause within the MSG3 (RRC Connection Request) message is determined by the Non-Access Stratum (NAS) procedure for which the connection is being established. The relationship between establishment cause and NAS procedure is specified by 3GPP TS 24.301. The example of anomalous behavior is where the WD 125 would continuously use the Emergency or High priority access despite not being needed. Since such causes have a higher priority to be served above other signaling, the continued anomalous behavior of the WD 125 may impact the S1 or NG interface in addition to the resources of the radio access network. Malicious behavior of this type may lead to exhausting the resources of the radio access network and prevent the functioning of the radio access network or access to the radio access network for other WDs 120 with possibly emergency requests.

An example of how this behavior may be identified as anomalous by a radio access network would involve a verification of subsequent activity of a UE that sends an establishment cause set to emergency. The typical behavior expected by a UE after an emergency establishment cause is for a voice call to be initiated and not general internet access for example. Thereby if the network does not detect the expected voice or possibly video call, this would indicate an anomalous behavior particularly if this type of establishment cause is initiated 3 or more times in a short time span such as 5 minutes.

A third example of anomalous behavior is the WD 125 providing a Fake Buffer Status Report. One of the Medium Access Control (MAC) protocol functions is the buffer status report (BSR), where the WD 120 sends to the network, a message informing the network how much uplink data the WD has awaiting in its data buffer. The radio access network will accordingly allocate the required resources for the scheduled WD 120 to send its buffered data. The BSR is an index (max is 63) which maps to a range of pending data size in the WD's data buffer. The radio access network will receive and process the BSR and proceed to schedule sufficient uplink grants for the buffered data. In the example of anomalous behavior, the WD 125 would forge the BSR index indicating that it has a high or maximum amount of data in its buffer which, for example, could be greater than 3 gigabytes. The radio access network would then grant the sufficient resources to the device. The WD 125 may then continue to send the forged message and thereby reserve significant available radio resources. Malicious behavior of this type may lead to exhausting the resources of the radio access network and denying access to other WDs.

An example of how this behavior may be identified as anomalous by a radio access network would involve measuring the amount of physical resource blocks (Prbs) the scheduler in the baseband is assigning to a specific UE. If the utilization is above a certain configurable threshold in the cell, for example 50% utilization for a time window of 10 seconds, the detection function may determine that this behavior may match or exceed this rule and thus be deemed as anomalous.

In a third step 220, the NF1 sends a request for the creation and startup of the NF2 to the network orchestrator 160 or a device fulfilling a function similar to the network orchestrator.

The network orchestrator then receives the request for the NF2 and in a fourth step 230, requests the hardware resources for and subsequently initiates a creation and startup of the NF2. The NF2 is created by the device it where the hardware resources, and the initiation of creation and startup have been requested. In the current embodiment, the NF2 is created and installed on the access network device. In other embodiments, the NF2 is created and installed on the device where it is or will be located. The NF2 sends a confirmation of successful creation and functioning of the NF2 to the orchestrator in a fifth step 240. The orchestrator then, in a sixth step 250, sends, to the NF1, a message comprising a confirmation of creation of the NF2. After step 250, the NF1 receives a message comprising a confirmation of creation of the NF2.

In a seventh step 255, the NF1 initiates a transfer or copying of a signaling context (260) associated with the WD and existing in the NF1, from the NF1 to the NF2. In some embodiments, NF1 transfers this signaling context to NF2. In other embodiments, the NF1 may transfer this signaling context to a different network function which sends the signaling context onward to the NF2. In some embodiments, the NF2 receives the signaling context belonging to NF1 from a different network function. The NF2 receives the transfer of signaling context associated with the WD and the NF1, whereby the transfer of the signaling context associated with the WD between NF1 and NF2 was internal to the radio access network. In an embodiment, the transfer of the signaling context may also be internal to the radio access network and the different network 170.

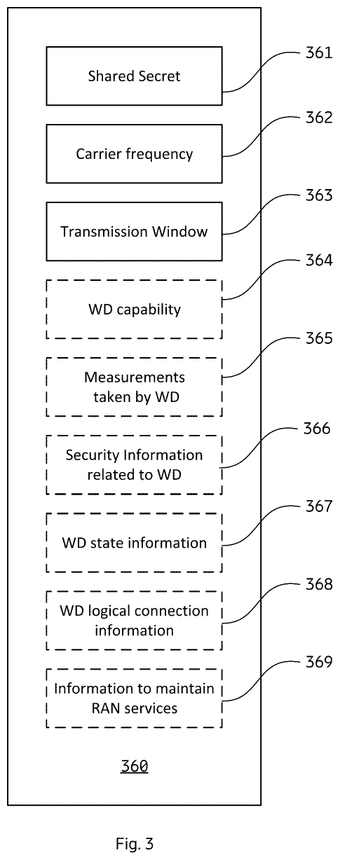

FIG. 3 illustrates an example of a signaling context 360 according to an embodiment of a method 200. Boxes with a solid outline illustrate features that the signaling context must contain while boxes with dashed outlines illustrate features that the signaling context may contain. The signaling context must at least comprise a shared secret or an identifier of the shared secret 361, such as a symmetric key identifier, between the radio access network and the WD, a carrier frequency 362 and a transmission reception window 363. The transmission reception window may comprise a time and a bandwidth. The signaling context may comprise different information critical to communication with the WD. Examples of critical signaling context are the NG-RAN node UE context as specified in 3GPP standard TS 38.401 Version 15.6.0, which stores all information needed for the WD and the associations between the WD and an gNB in a 5G context, and the eNB UE Context as specified in 3GPP standard TS 36.401 Version 13.1.0, which stores all information needed for the WD and the associations between the WD and an eNB. The transfer of this signaling context is what allows NF2 to appear to the WD as NF1. The signaling context may also comprise one of, or any combination of the following: the capability 364 of the wireless device such as transmission frequency capability and 3GPP standard compatibility; information indicative of measurements 365 taken by the WD such as measurement reports; information indicative of security 366 related to the WD such as UE security capability, UE security context (e.g. 5G Access Stratum security context and/or 5G Non-access Stratum Security context), encryption certificates or keys (e.g. integrity keys and/or encryption keys); information of a WD state information 367 such as RRC states and RRC state transitions; and information indicative of a WD associated logical connection 368 with a network function located in either the access network device, the radio access network, or the different network. Examples of information indicative of a WD associated logical connection with a network function are gNB-CU UE F1 AP ID for F1 connections and eNB UE S1AP ID for S1 connections. The signaling context may also comprise information required to maintain radio access network services 369. An example of these services could be in the control plane services such as requesting a service, controlling different transmission resources, and the connection between WD and the network. Other examples could be in the user plane services such as transferring user data through the access stratum. Examples of the information required for these services may be the RRC states; UE radio capability such as supported frequency bands, UE category or UE features; UE aggregate maximum bit rate; or Quality of Service flow IDs. Without this transfer of signaling context, the signaling could either not continue or would lead to informing the WD that it was no longer communicating with NF1 and instead NF2. This would thereby disrupt any attempt at deception by the access network device towards the WD.

In a more general context, any procedure that may alert the WD to the transfer or copying of the signaling context would disrupt any attempt at deception by the access network device towards the WD. The access network device should not trigger any procedures that may indicate or alert the WD to the transfer or copying.

In another embodiment, Steps 220 through 255 or similar occur before step 210. All that is required is that NF1 is aware of the anomalous WD and an identifier associated with the WD, e.g. an ICCID, IMEI or a SUPI such as IMSI or network access identifier (NAI). This would allow for the initialization of NF2 before the WD attempted to exchange signaling with the radio access network and thereby possibly reduce the amount of signaling necessary between the network and the WD before the signaling of the WD is transferred to NF2.

Following step 255 or in the case of the embodiment described above, step 210, the NF1 would then, in an eighth step 270, initiate either redirection of signaling arriving at NF1 from the WD towards NF2 or initiate a transfer of the signaling whereby signaling would arrive directly to NF2 from the WD. Both of these require the signaling context to be transferred beforehand. This would lead to a cessation of transmission to the WD from the network function currently providing for radio access. The NF2 should be indistinguishable from the NF1 to the WD when initiating a transfer of the signaling associated with the WD from the NF1 to the NF2. In an embodiment, when initiating a transfer of signaling associated with the WD from NF1 to NF2, the NF2 uses information indicative of an identity associated with NF1. An example of such an identity would be a base station identity code, eNB-ID, cell global identity, gNB-ID, NR cell global identifier or similar.

In a ninth step 280, the WD signaling is sent from the WD to the NF1, which then forwards the WD signaling to the NF2. The NF1 thus acts as a passthrough device. This step is not necessary if the signaling is sent and received by NF2 either directly from the WD or, in a different embodiment, through a different network function. These embodiments allow NF1 to be completely isolated from any interaction with the WD. In another embodiment, the access network device stops transmission to the WD from NF1 that is currently providing radio access and begins transmission to the WD, wherein the transmission originates from NF2 using the signaling context from NF1.

In a tenth step 285, the NF2 receives signaling from the WD, whereby the transfer of the signaling context associated with the WD between the NF1 and NF2 was internal to the radio access network. In another embodiment, the transfer of the signaling context was internal to both the radio access network but also the different network. This would result in a beginning of transmission to the WD, wherein the transmission originates from the NF2 using the same signaling context. The NF2 communicates with the WD via signaling between both. This interaction should not contain any signaling, to the WD, indicative of a transfer from the NF1 to the NF2 or indicative of NF2 sharing the signaling context of NF1. In one embodiment, this interaction is contained between the NF2 and the WD. This interaction may, for example, involve strictly the control plane functionality of the network and may simply ignore or obfuscate any user plane functionality requested by the WD. This interaction may also attempt to replicate some or all user plane signaling. In another embodiment, the user plane signaling may be further transmitted to another network function such as the core network or a network function appearing to the WD as the core network. This may expand to an entire network slice being created and operated which would appear to the WD as a real network or a real network slice.

Furthermore, in certain embodiments, the access network device monitors and/or records all signaling taking place between the WD and the NF2. The access network device may also store and transmit records of the signaling. This would allow for the gathering of intelligence of anomalous behavior of the WD and help determine if the WD was engaging in abnormal, suspicious, or even malicious activity, what the activity was and what the goal of the activity was. This gathered intelligence would otherwise risk incurring damage or otherwise compromising of the access network device if conducted using NF1. Without the invention, this type of monitoring and logging may be a risk to the network and the underlying infrastructure and thereby should not be allowed on normal network functions.

Once a number of interactions are performed by either the NF2 or the WD or a certain interaction or set of interactions has taken place between the NF2 and the WD, the NF2 then, in an eleventh step 290, requests to be terminated. The access network device and any network function therein may also send a message to a network orchestrator requesting the termination of the NF2. A network function outside of the access network device may also send a message to a network orchestrator requesting the termination of the NF2. The request for termination may also take place after a certain amount of time or an amount of computational resources is or has been utilized such as memory or processor clock cycles. In another embodiment, the network function may also be requested for termination if the WD no longer sustains any signaling with the NF2, the access network device, or the radio access network. The WD may no longer sustain the signaling in an instance where, for example, the WD leaves the network. The orchestrator then terminates NF2 and releases the resources allocated to NF2 in a twelfth step 295. In other embodiments, the access network device terminates the NF2 and releases the resources allocated to NF. This termination and release may be done upon request of the network orchestrator. This termination and release of NF2 would also terminate any ongoing signaling with the WD. In certain embodiments, the signaling with the WD would only be terminated after a certain set of interactions would be initialized and carried out in order to obfuscate any deception by the access network device towards the WD. This termination serves both to save the computational resources of the access network device while also allowing for the access network device to waste the resources of the anomalous device towards a specific network function and stall any potentially anomalous or even malicious activities. In the event of termination, the access network device would receive a message comprising a confirmation of the termination of the NF2. This message may be received from the network orchestrator.

FIG. 4 schematically illustrates an example of a 5^{th} generation radio access network comprising a gNB and a 5G Core, 5GC, connected via a NG interface. Additionally, the gNB may be connected with another gNB via an Xn interface. The gNB comprises a gNB Centralized Unit, gNB-CU, and one or more gNB Distributed Units, gNB-DU. Communication between the CU and DU is done using an F1 interface. Finally, communication between the WD and the radio access network is done with the gNB-DU over the air interface, Uu.

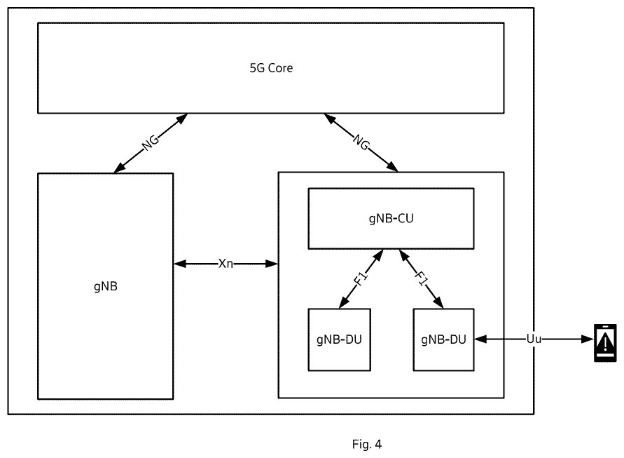

FIG. 5 schematically illustrates an embodiment of the current disclosure in a 3GPP 5^{th} generation radio access network context specifically Release 16. While the core inventive concept is the same as in previous embodiments, the exact embodiment is different and should not be considered exactly complementary to other embodiments. It should be clear to the skilled person how the details of the embodiment presented in the 3GPP 5^{th} generation radio access network may be changed to better suit not only other 5^{th} generation radio access networks but also other radio access networks such as previous 4^{th} generation and a future 6^{th} generation radio access network. This may even be extended to other non 3GPP networks whereby the network is a radio access network using the required signaling context as described in FIG. 2 and the invention as claimed.

The embodiment of FIG. 5 illustrates a 5^{th} generation radio access network 500 with connected wireless devices, WD, where a WD 120 exhibits normal behavior and a different WD 125 exhibits anomalous behavior. The radio access network also comprises a base station in the form of a gNB which in the present embodiment contains a radio antenna 510 connected to an access network device 530, which then connects to a 5GC 580. The access network device initially comprises two network functions. The first network function 560, NF1, as, or performing the role of, the gNB Centralized Unit, gNB-CU. In some embodiments the NF1 may only perform the role of the gNB Centralized Unit Control Plane, gNB-CU-CP, function and thereby only interact with the WD through the control plane. The other network function 550, NF3, functions as, or performs the role of, the gNB Distributed Unit, gNB-DU. NF3 may also perform any role providing functions normally provided by a gNB-DU. In the present embodiment, the access network device also contains a network orchestrator 570, which assists in starting, stopping, and managing network functions in and possibly outside of the access network device. The network orchestrator may also exist outside the access network device such as in FIG. 1. The access network device may also contain more network functions than NF1 and NF3. In the current embodiment, the access network may at certain moments contain a second network function 565, NF2 and a fourth network function 555, NF4. To the WD, the NF2 will appear to be NF1, acting as a gNB-CU or and the NF4 will appear to be NF3, acting as a gNB-DU. The NF2 and NF4 may have at least some capabilities of the NF1 and NF3 respectively. Both of these may be created and terminated by the access network device upon receiving a request from the network orchestrator. In certain embodiments, there may exist a fifth network function 585, NF5, which may exist inside or outside of the access network device which will appear to the WD as the 5GC or some component of the 5GC such as the AMF. In this embodiment the NF5 would be logically separate from the 5GC. Solid lines with arrows indicate the path of signaling from a normal non-anomalous WD 120 through the network. The dashed lines with arrows indicate the path of signaling from the anomalous WD 125 as well as any signaling caused as a result of the existence and signaling of the anomalous WD.

Both NF2 and NF4 appear to the WD as NF1 and NF3 respectively. Both also share characteristics of a software sandbox in which the network functions have different functionality for the expressed purpose of preventing the WD from interacting with other network resources such as NF1 and NF3 for example. If the WD is to interact with other network resources, it should be in a very specific manner depending on the implementation although with the priority being to limit security risk to the radio access network. General examples of such sandboxes in other networks besides radio access networks are well known in the prior art. An example of some characteristics of network function sandboxes would be a gNB-CU sandbox which contains all the direct functionality of the control plane but no ability to communicate with the core network, gNBs, other DUs outside of the DU responsible for signaling with the WD or any other component of the radio access network. This would prevent the WD from interacting with any sensitive equipment associated with the radio access network outside of the network function sandboxes.

FIG. 6 illustrates a signaling diagram of an embodiment of the method 600 of the current disclosure. Method 600 is an embodiment of the invention as described by the claims for a 5^{th} generation radio access network 500 where all network functions are already started and running when an anomalous WD 125 is detected by NF1 560. In a first step 605, the access network device starts by having the NF1, in the from the gNB-CU, receive anomalous signaling from the WD. The NF1 then proceeds to, in a second step 610, initiate the transfer of responsibility for communicating with the WD to the NF2 565, the NF2 being in the form of a sandbox version of the gNB-CU. This initialization of transfer comprises initiating a transfer or copying of the WD signaling context. This is essential for the NF2 to appear as the NF1 in subsequent communications with the WD. In another embodiment, the NF3 may also initiate transfer of a signaling context associated with the WD from NF3 to the NF2. In yet another embodiment, the NF3 may also initiate transfer of a signaling context associated with the WD from the NF3 to the NF4. In these embodiments, the signaling context from NF3 contained all requirements for NF2 to appear as NF1 to the WD, the NF1 may not need to initiate a transfer a signaling context to NF2. The signaling context associated with NF1 should have, either partially or completely, originated with NF1. The transfer of signaling context may occur over the F1 interface.

Using this UE signaling context to identify the correct WD, the NF2 then, in a third step 615, proceeds to initiate an F1 UE Context Setup Procedure by send a UE context setup request to the NF4 555 which is in a sandbox form of a gNB-DU. The NF3 550 then sends a response to the request in a fourth step 620 which allows the NF2 finish setting up the F1 interface and to acknowledge, to the NF1 in a fifth step 625, successful transfer of responsibility for communicating with the WD.

With this acknowledgement, the NF2 proceeds to initiate, in a sixth step 630, an F1 UE context modification procedure by sending a UE context modification request to NF3 which would result in the specific embodiment where the NF3 simply transfers signaling to the NF4 through the F1 interface without notifying the WD of any change. Additionally, in this embodiment the F1 UE context modification procedure would contain an additional informational element to mark the corresponding gNB-CU UE F1AP ID and gNB-DU UE F1AP ID as belonging to the anomalous WD.

More generally, the access network device would initiate a redirection of signaling associated with the WD, from NF3 to NF4 and maintain the redirection internally to the access network device. In another embodiment, the access network device would initiate a transfer of signaling associated with the WD, from either NF1 to NF2 or NF3 to NF4 and maintain the transfer internally to the access network device. The access network device would initiate the transfer of signaling whereby the initiating comprises the transmission of a message of the F1 interface containing an informational element.

The informational element would indicate information indicating a WD exhibiting or associated with an anomalous behavior of the WD wherein the informational element causes the access network device to cease any signaling to the WD indicative of a transfer. Another embodiment is the informational element to cause the NF1 to cease signaling with the WD and cause the NF2 to send a message indicating a statis of the transfer of signaling associated with the WD. The status may indicate success if the NF2 can successfully communicate with the WD using the signaling context of NF1 and may indicate failure if the NF2 cannot communicate with the WD using the signaling context of NF1 or has informed the WD of the transfer of the signaling context or signaling. This would let the NF1 alert the NF3 to the anomalous nature of the WD. This would then enable the NF3 to not alert the WD of the modification request and the resulting redirection or transfer of signaling. An embodiment of this informational element could be a Boolean flag named Anomalous Flag. A further embodiment is for the NF1 not to include a Transmission Action Indicator in the modification message and thereby preventing the notification of the WD that would normally occur as a result. A similar embodiment is for the modification request part of the procedure to not include an RRC connection reconfiguration message for substantially the same reasons.

In another embodiment, the NF3 may initiate a transfer of signaling associated with the WD from NF3 to the NF2. This may be through NF4, as shown in the above embodiment, or directly to the NF2 through an F1 interface set up by a similar F1 context modification procedure as previously but with the destination being NF2. This would occur in instances where the access network device does not contain an NF4.

NF3 then, in a seventh step 635, responds to the modification request from NF1. This allows the NF1 to, in an eighth step 640, confirm a successful transfer of signaling destination to the NF2. To further clarify, this modification should in no way indicate any of the previously mentioned activities in method 600 to the WD.

From here in a ninth step 645 and a tenth step 650, the signaling with the WD resumes with NF4 sending relevant signaling in regard to where the communication was left off in step 605 which passes through NF3 and signaling coming in from the WD passing through NF3 then to NF4 and finally to NF2. This then completes the transfer, which could also be called a migration, of the WD from NF1 to NF2 in a 5^{th} generation radio access network context where all network functions exist and are running.

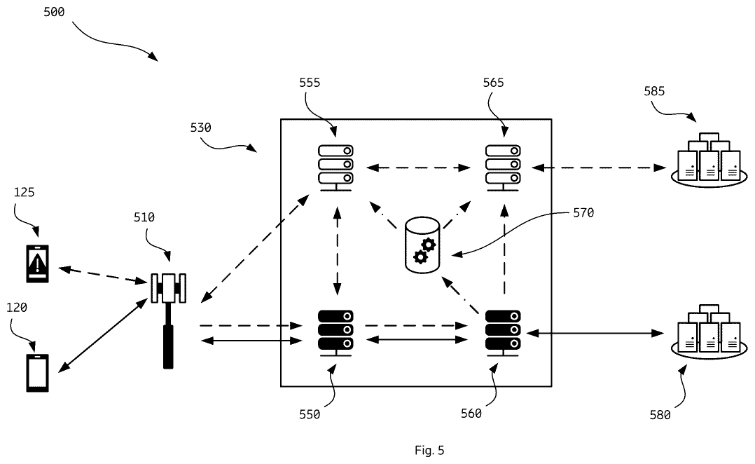

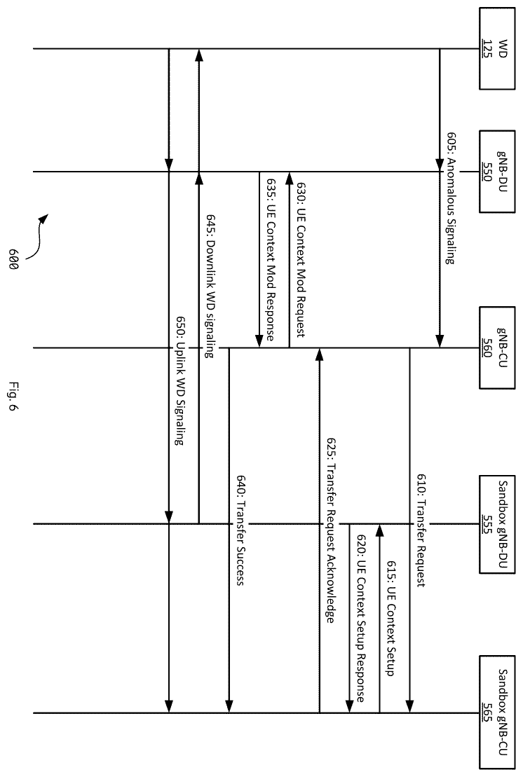

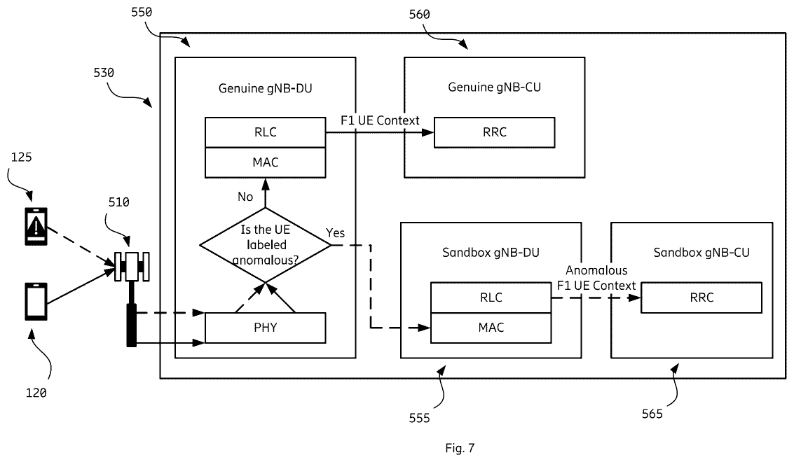

FIG. 7 illustrates an example of how signaling involving sandbox network functions would take place in the 3GPP 5^{th} generation radio access network 500. In this embodiment, a successful transfer of signaling has taken place and the WD has not been informed in any way of the transfer. In FIG. 7, the dashed lines are indicative of signaling from the anomalous WD 125 and the solid lines are indicative of signaling from the WD 120. Signaling from both WDs travel through the same physical antenna 510 and moves to the access network device 530 and to NF3 550, here labeled as a genuine gNB-DU. The physical layer of NF3 receives signaling and here necessary information is parsed to allow for other logical functions to further process and handle the signaling. One embodiment is once signaling has passed into and through the physical layer, the NF3 decides which signaling belongs to which WD. In the case of the anomalous WD signaling, the signaling is then transferred to the logical layers, for example MAC and Radio Link Control, of NF4, labeled here as a sandbox gNB-DU. From there the signaling is then sent over the dedicated F1 interface for the anomalous WD set up in method 600, directly to the NF2, labeled here as a sandbox gNB-CU, where the signaling is received and then contained to that network function. In other words, the NF2 may interact with either NF3, NF4, or both, with the interactions being informed by interactions with the WD. In some embodiments, the NF2 may not interact with any other network functions or device beyond NF3, NF4, or both. These interactions may take the form of signaling. In the case of non-anomalous WD 120 signaling, the signaling is handled by the internal logical functions of NF3 and then sent over a standard F1 interface to NF1, labeled as the genuine gNB-CU, where the WD 120 is then handled normally as per the specification of the radio access network. In certain embodiments, signaling from one or both of types of WDs 120,125 is strictly associated with the control plane whereas in other embodiments, signaling is both for the control plane and user plane.

In an embodiment of the invention, the interactions the NF2 may have with the WD 125 through the NF3 and NF4 should be contained to these functions and logical functions should be contained to NF2, NF4, or both. For example, in the 4^{th} and 5^{th} generation 3GPP radio access networks, all RRC functions may be contained to the NF2. More generally, all interactions between the radio access network and the WD 125 categorized as layer 3 and above by the OSI model may be contained to the NF2. Interactions associated with layer 2 may be contained to the NF2 and NF4 and interactions associated with layer 1 may be contained to NF2, NF3, and NF4.

Examples of these interactions between the NF2 and the WD 125 and which, by extension may include the NF3 and NF4, follow below. One example may be in a 5^{th} generation network where the NF2 may answer repeated and anomalous RRC requests by delaying a response. This may be done by delaying the random-access procedure responses known as MSG2, delaying the RRC connection setup known as MSG4 or by other means so long as completing the end-to-end authentication and registration procedure with the core network is not done. During these, the NF2 keeps monitoring and logging these interactions and may provide this information to other network devices or functions to enable the implementation of more granular security policies to protect against further and future attacks. One example of such as security policy may be to initiate a transfer of responsibility to the NF2 of, or cease all signaling to, a future WD exhibiting the anomalous behavior of repeated RRC connection establishment requests in the form of repeated MSG1 (RACH) or MSG3 (RRC Connection Request) after the WD has sent 5 repeated RRC requests without the MSG3 or MSG5 (RRC Connection Setup) response respectively.

In a different embodiment, NF2 is capable of communicating with the NF5, which may appear to the WD as an AMF in a 5^{th} generation network. In other embodiments, the NF may appear as part of or an entire core network to the WD. This would mean the WD would see an entire network slice which would be separated from the network that is interacting with a different WD through NF1. In other words, the NF2 may interact with NF5, with the interactions being informed by interactions with the WD. These interactions may take the form of signaling.

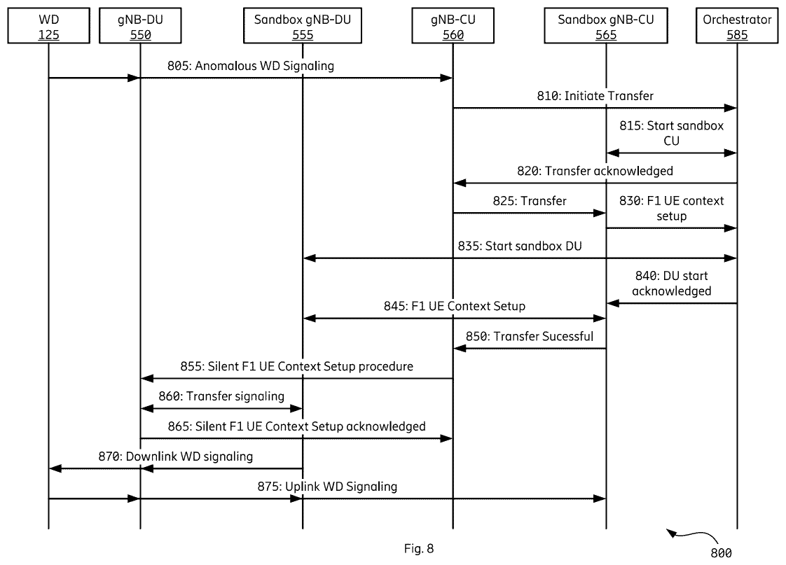

FIG. 8 illustrates a signaling diagram of an embodiment of the method 800 of the current disclosure. Method 800 is an embodiment of the invention as described by the claims for the 3GPP 5^{th} generation radio access network 500 where no sandbox network functions have been started or are running when an anomalous WD is detected by NF1. This serves to illustrate how these network functions may be started during runtime in the event of obtaining information indicative of anomalous behavior associated with a WD.

A first step 805 begins with the NF1, which functions as a gNB-CU in the embodiment of FIG. 8, receiving signaling from a WD that exhibits or has exhibited anomalous behavior. The WD or WD associated signaling may be unknown to the NF2. In this case, detection that the WD's behavior is indeed anomalous must occur in order to label the WD as having an anomalous nature, or the NF1 may be already aware of the anomalous nature of the WD from some internal or external database. This detection may have occurred in the NF1 or in some other function or device whereby NF1 is indicated to, that the WD exhibits of has exhibited anomalous behavior.

Once the NF1 has received signaling from the anomalous WD, a second step 810 begins with the NF1 initiating a transfer of responsibility for interacting with the WD to the network orchestrator. The network orchestrator then, in a third step 815, sends a message to the access network device to initialize NF2, which will appear as a gNB-CU to the WD. NF2 is then initialized by the access network device. Then, in a fourth step 820, the network orchestrator acknowledges to the NF1 a successful startup of NF2. The access network function, or specifically the NF1, receives the acknowledgement from the network orchestrator indicating a successful startup of NF2. To complete the initialization of NF2, the NF1, in a fifth step 825, initiates a copying and/or transfer of the signaling context associated with the WD, to the NF2. This allows the NF2 to appear to the WD as NF1 and for a deception to occur. Without this copy or transfer, NF2 is unable to appear to the WD as NF1 making deception unable to be conducted in the RAN context. NF2 receives the signaling context associated with the WD and NF1.

In a sixth step 830, the NF2 indicates to the network orchestrator to start up NF4 which appears to the WD as a gNB-DU. Comprising this indication is a F1 UE context for which the NF4 should be prepared to set up an F1 UE context with NF2 once started and connected to NF2. The network orchestrator proceeds to send a message to the access network device to initialize NF4 in a seventh step 835. The access network device initializes NF4. With successful initialization, the network orchestrator may move to an eighth step 840 and notify the NF2 of successful initialization of NF4.

In some embodiments, the NF3 and NF4 may be located in a different access network device than NF1 and NF2. In this embodiment the network orchestrator is able to initialize NF2 and NF4 as software running in the same computational environment as NF1 and NF3 respectively in the same access network device. The network orchestrator may also initialize NF2 and NF4 as a containerized application, for example using a Docker type solution. The network orchestrator may also initialize NF2 and NF4 in fully separate from NF1 and NF3 in terms of hardware and/or software where dedicated communications interfaces are required for the network functions to communicate.

In a ninth step 845, NF2 proceeds to setup an F1 UE context with NF4 which informs NF4 to connect to NF2 over the F1 link and use the F1 context to handle singling between NF2 and the WD. Once an F1 context is established between NF2 and NF3, NF2 will then signal to NF1 that the network functions required to take over responsibility for the WD are in place and functioning in a tenth step 850.

The last set of steps before signaling to the WD may take place, is for an F1 UE context to be setup between NF3 and NF4 and onward to NF2 instead of the current path from NF3 to NF1. In an eleventh step 855, the NF1 initiates an F1 UE Context Modification procedure. This modification procedure directs the NF3 to prepare to transfer responsibility for processing all logical layer protocols, for example MAC and RLC in 5^{th} and 4^{th} generation radio access networks to NF4. This modification should not in any way indicate to the WD that a modification is taking place which would occur for example if the modification procedure included a RRC reconfiguring procedure. Such a procedure is also unnecessary given the earlier transferred WD signaling context to NF2. Another embodiment of this procedure may also be that the NF3 is modified in such a way that all signaling is directly transferred through an F1 context directly to NF2. In a twelfth step 860, NF3 and NF4 agree to and initiate the new signaling path from, for example, NF3's physical layer to NF4's MAC and RLC layers. Once initiated, the NF3 acknowledges, in a thirteenth step 865, the silent F1 context modification to NF1. This allows NF1 to release any responsibility over the anomalous WD and allow NF2 to handle further signaling through NF4 and NF3 as in, for example, FIG. 7.

When ready or on request from NF2, the NF4 resumes, in a fourteenth step 870, signaling through NF3 to the WD. As per the modified signaling responsibilities of NF3 and NF4 and through the new F1 context between NF4 and NF2, signaling from the WD is then sent to NF2 from the WD 125 in a fifteenth step 875. This allows, in an embodiment, for continued signaling to resume such as depicted, for example, in FIG. 7.

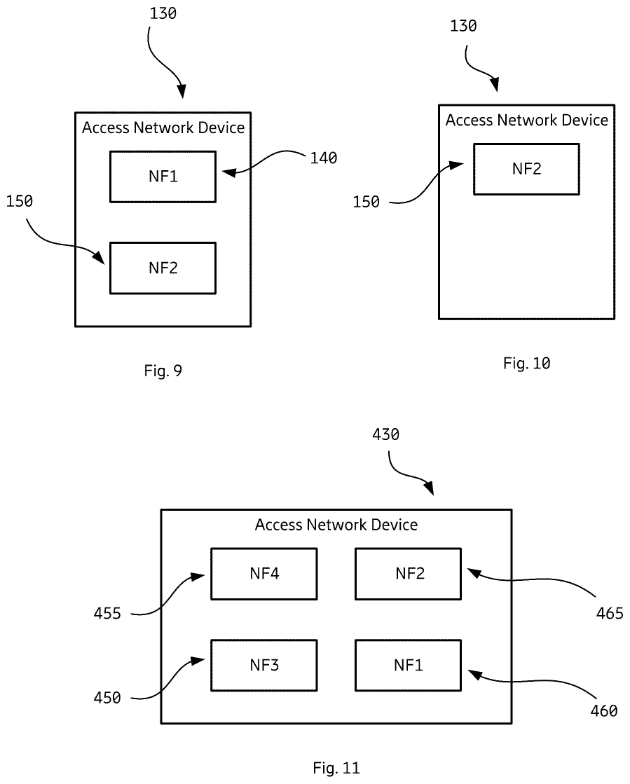

FIG. 9 depicts an example architecture of an access network device 130 according to an embodiment of the invention. The access network device is shown with two network functions, NF1 140 and NF2 150 inside. The NF1 and NF2 is in one embodiment of the access network device embodied as computer programs run on the access network device. In another embodiment, both the NF1 and NF2 are implemented as hardware circuits.

FIG. 10 depicts an example architecture of an access network device 130 according to an embodiment of the invention. The access network device is shown with one network function, NF2 150 inside.

FIG. 11 depicts an example architecture of an access network device 530 according to an embodiment of the invention. The access network device is shown with four network functions, NF1 560, NF2 565, NF3 550, and NF4 555 inside.

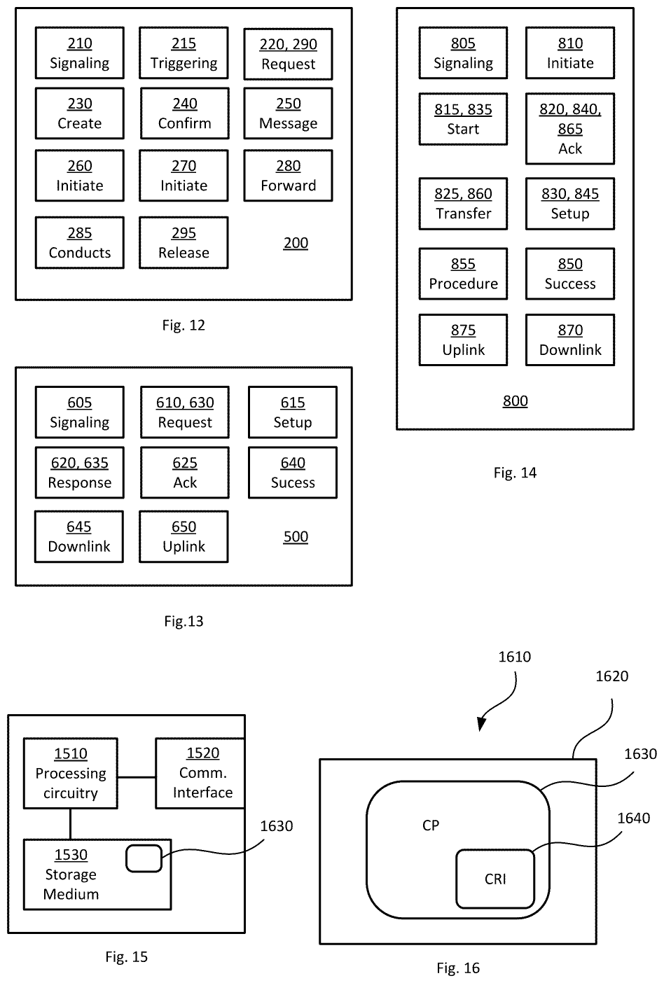

FIG. 12 is a diagram showing functional units of an access network device 130 according to some embodiments. As shown in FIG. 12, the client comprises a number of functional modules; a signaling module configured to perform step 210; a triggering module configured to perform set 215; a request module configured to perform steps 220 and 290; a create module configured to perform step 230; a confirm module configured to perform step 240; a message module configured to perform step 250; an initiate module configured to perform step 255; an initiate module configured to perform the steps 270; a forward module configured to perform step 280; a conducts module configured to perform step 285; and a release module configured to perform step 295. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the access network device 130 as disclosed herein.

FIG. 13 is a diagram showing functional units of an access network device 530 according to some embodiments. As shown in FIG. 13, the client comprises a number of functional modules; a signaling module configured to perform step 605; a request module configured to perform steps 610 and 630; a setup module configured to perform step 615; a response module configured to perform steps 620 and 635; an acknowledgement module configured to perform step 625; a response module configured to perform the steps 635; a success module configured to perform step 640; a downlink module configured to perform step 645; and an uplink module configured to perform step 650. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the access network device 530 as disclosed herein.

FIG. 14 is a diagram showing functional units of an access network device 530 according to some embodiments. As shown in FIG. 14, the client comprises a number of functional modules; a signaling module configured to perform step 805; an initiate module configured to perform step 810; a start module configured to perform steps 815 and 835; an acknowledgement module configured to perform steps 820, 840, and 865; a transfer module configured to perform steps 825 and 860; a setup module configured to perform steps 830 and 845; a success module configured to perform step 850; a procedure module configured to perform step 855; a downlink module configured to perform step 870; and an uplink module configured to perform step 875. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the access network device 530 as disclosed herein.

FIG. 15 is a block diagram of the access network device 130, 530 according to some embodiments. As shown in FIG. 15, the access network device 130, 530 may comprise: processing circuitry 1510 which may include one or more processors (e.g., a general purpose microprocessor and/or one or more processors, such as an application specific integrated circuit (ASIC), field-programmable gate arrays (FPGAs) and the like); a communications interface 1520 for communicating with other nodes connected to a network 100,500; and a storage medium 1530 which may include one or more non-volatile storage devices and/or one or more volatile storage devices (e.g., random access memory (RAM)). In embodiments where the smart proxy includes a programmable processor 1510, a computer program product may be provided. A computer program product includes a computer readable medium 1620 such as, but not limited to, the storage medium 1530, magnetic media (e.g., a hard disk), optical media, memory devices, and the like. The storage medium may contain a computer program 1630 containing computer readable instructions 1640 that when executed by the processor circuit 1510 causes the processor circuit to perform operations according to embodiments disclosed herein. According to other embodiments, processor circuitry 1510 may be defined to include a storage medium so a separate storage medium is not required.

FIG. 16 is a diagram showing an embodiment of the invention. As shown in FIG. 16, the computer program product 1610 comprises a computer readable medium 1620 storing a computer program 1640 comprising computer readable instructions 1640. The computer readable medium may be but not limited to, a storage medium 1530, magnetic media (e.g., a hard disk), optical media, memory devices (e.g., random access memory, flash memory) and the like.

Also, while various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed in a radio access network by an access network device comprising a first network function, NF1, and a second network function, NF2, the method comprising:
obtaining, in the NF1, information indicating an anomalous behavior of a wireless device, WD;
initiating copying or transfer of a signaling context associated with the WD and existing in the NF1, from the NF1 to the NF2.

2. The method according to claim 1, wherein the signaling context comprises the following:
a shared secret or an identifier of the shared secret;
a carrier frequency; and
a transmission reception window comprising a time and a bandwidth.

3. The method according to claim 2, wherein the signaling context comprises one or more of the following:
information indicative of WD capability;
information indicative of measurements taken by the WD;
information indicative of security related to the WD;
information indicative of information required to maintain radio access network services;
information indicative of WD state information; or
information indicative of a WD associated logical connection with a network function, the network function located in:
the access network device;
the radio access network; or
a different network.

4. The method according to claim 1, the method comprising:
stopping transmission to the WD from NF1 currently providing radio access; and
beginning transmission to the WD, wherein the transmission originates from NF2 using the signaling context from NF1.

5. The method according to claim 1, the method comprising:
initiating transfer of a signaling associated with the WD, from the NF1 to the NF2wherein, during the transfer and thereafter the NF2 uses information indicative of an identity associated with NF1.

6. The method according to claim 1, the method comprising:
deriving information indicative of an anomalous behavior of the WD by receiving a signaling from the WD.

7. The method according to claim 1, the method comprising:
obtaining the information indicating the anomalous behavior of the WD from one or a combination of:
a database;
the access network device; and
a detection function.

8. The method according to claim 1, the wherein the anomalous behavior including one or more of:
repeated signaling associated with the WD;
unexpected signaling associated with the WD;
non 3GPP compliant signaling associated with the WD;
previously identified anomalous identifier associated with the WD;
anomalous location of the WD; or
anomalous measurement reporting by the WD.

9. The method according to claim 1, the method comprising
initiating the creation of NF2.

10.-11. (canceled)

12. The method according to claim 1, the method comprising:
terminating the NF2.

13. The method according to claim 12, the method comprising:
terminating the NF2 after either:
a set amount of time;
an amount of time where no interactions with the WD occur.
a number of interactions with the WD; or
an amount of access network device resources used;

14.-15. (canceled)

16. The method according to claim 1, wherein the access network device comprises a third network function, NF3.

17. The method according to any one of claims 16, wherein the access network device comprises a fourth network function, NF4.

18. The method according to claim 17, the method comprising:
creating the NF4.

19. The method according to claim 17, the method comprising:
sending a message to a network orchestrator requesting the creation of the NF4.

20. The method according to claim 17, comprising:
receiving from a network orchestrator a message comprising a confirmation of creation of the NF4.

21. The method according to claim 16, the method comprising:
initiating transfer of a signaling context associated with the WD, from the NF3 to the NF2.

22. The method according to claim 17, the method comprising:
initiating transfer of a signaling context associated with the WD, from the NF3 to the NF2 and/or the NF4.

23. The method according to the method of claim 16, the method comprising:
initiating transfer of a signaling associated with the WD, from the NF3 to the NF2.

24. The method according to the method of claim 17, the access network device comprising:
the NF4 with at least some capabilities of a NF3 and NF4 uses information indicative of an identity associated with as the NF3 to the WD.

25.-37. (canceled)

38. The method according to claim 1, the method comprising:
monitoring the received signaling from the WD.

39. The method according to claim 38, the method comprising:
recording the received signaling from the WD.

40. The method according to claim 39, the method comprising:
storing records of the received signaling from the WD.

41. The method according to claim 40, the method comprising:
transmitting the records of the received signaling from the WD.

42. The method according to claim 1, the method comprising:
terminating the NF2.

43. The method according to claim 42, the method comprising:
terminating the NF2 after either:
a set amount of time;
an amount of time where no interactions with the WD occur;
a number of interactions with the WD; or
an amount of access network device resources used.

44. The method according to claim 1, the access network device comprising:
a third network function, NF3.

45. The method according to claim 1, the access network device comprising:
a gNodeB Distributed Unit as the NF3;

46. The method according to claim 1, the access network device comprising:
a third network function, NF3, and fourth network function, NF4;
the NF4 having at least some capabilities of a NF3 and appearing the same as the NF3 to the WD.

47. The method according to claim 1, wherein the access network device is a 3GPP 5G access network device.

48. The method according to claim 1, the access network device comprising:
a second network function NF2, where NF2 has at least some of the capabilities of a gNB-CU and appears the same as a gNB-CU to the WD.

49. The method according to claim 44, the method comprising:
NF2 interacting with the NF3, the interaction being based on interactions with the WD.

50. The method according to claim 46, the method comprising:
interacting at NF2 with a fourth network function, NF4, the interactions being based on interactions with the WD.

51. The method according to claim 43, the method comprising:
interacting at NF2 with a fifth network function, NF5, the interactions being based on interactions with the WD.

52. The method according to claim 51, the method comprising:
interacting at NF2 with the NF5, NF5 having at least some of the capabilities of a core network connected the access network device and appearing the same as a core network to the WD.

53. The method according to claim 51, the method comprising:
interacting at NF2 with the NF5, NF5 having at least some of the capabilities of an Access and Mobility Management Function connected to the access network device and appearing the same as an AMF to the WD.

54.-64. (canceled)
